(19) United States
(12) Patent Application Publication
(10) Pub. No.: US 2016/0343349 A1
(43) Pub. Date: Nov. 24, 2016

(54) LED DISPLAY APPARATUS AND VIDEO DISPLAY APPARATUS

(71) Applicant: MITSUBISHI ELECTRIC CORPORATION, Tokyo (JP)

(72) Inventors: Naoyuki MACHIDA, Tokyo (JP); Shigenori SHIBUE, Tokyo (JP); Yoshinori ASAMURA, Tokyo (JP)

(73) Assignee: MITSUBISHI ELECTRIC CORPORATION, Tokyo (JP)

(21) Appl. No.: 15/144,518

(22) Filed: May 2, 2016

(30) Foreign Application Priority Data
May 20, 2015 (JP) 2015-102457

(51) Int. Cl. G09G 5/10; G09G 5/14; G09G 5/04; G09G 3/32; G09G 3/20

(52) U.S. Cl. CPC G09G 5/10; G09G 3/32; G09G 3/2003; G09G 5/04; G09G 5/14; G09G 2320/0233; G09G 2300/026

(57) ABSTRACT

An LED display apparatus includes an LED aging unit, a correction factor computing unit, and a luminance correction circuit. The LED aging unit includes an LED aging display that includes at least one second LED, a luminance measurer that measures luminance decrease rates of the second LED per color correspondently to lighting periods of first LEDs, and a luminance decrease rate storage that stores the luminance decrease rates. The correction factor computing unit computes correction factors for correcting luminances of the first LEDs per color in accordance with cumulative lighting periods of the first LEDs of corresponding colors and the luminance decrease rates of corresponding colors. The luminance correction circuit corrects the luminance of the first LEDs per color in accordance with the correction factors.

### FIELD OF THE INVENTION

The present invention relates to LED display apparatuses and video display apparatuses including a plurality of LEDs arranged in a matrix and controlling flashing of individual LEDs to display video information, and more particularly relates to a technique for controlling luminances of the LEDs.

### DESCRIPTION OF THE BACKGROUND ART

LED display apparatuses including LEDs (light-emitting diodes) are widely used to display, for example, advertisements indoors and outdoors owing to technical development associated with LEDs and reduction in cost of LEDs. Although the LED display apparatuses have been mainly used to display moving images such as natural pictures and animations, the LED display apparatuses for indoor use have reduced pixel pitches to achieve shorter visual distances, and thus are also used to display images on personal computers in meeting rooms, personal computers performing monitoring, and the like. In particular, the LED display apparatuses for use in monitoring often display images similar to still images on personal computers. The luminances of the individual LEDs decline as the lighting periods of the LEDs increase, and thus the luminance decrease rates of the individual LEDs vary depending on contents of images, leading to pixel-to-pixel variations in luminance and color.

The following methods have been proposed to reduce such variations in luminance and color. According to one method (see, for example, Japanese Patent Application Laid-Open No. 11-015437 (1999)), the luminance of the individual LED is detected, and then the luminance data is corrected. According to another method (see, for example, Japanese Patent Application Laid-Open No. 2006-330158), the display periods of the individual LEDs are accumulated, and then the luminance is corrected, using a luminance correction factor measured in advance in accordance with the accumulated periods.

In dealing with variations in luminance and color caused by differences in lighting period among the individual LEDs, the luminance decrease rates of the individual LEDs can be predicted to some extent in life tests or the like, but it is difficult to predict differences in characteristics of LEDs, which vary from production lot to production lot. Detecting the actual luminance of the LED display apparatus can improve the accuracy of correction but necessitates the displaying of an image for measuring luminance. It has been therefore necessary to halt a 24-hour operation system. Such a halt has hindered the improvement in accuracy of correction and failed to eliminate variations in luminance and color, causing deterioration in the display quality of the LED display. This problem has been inevitably solved by replacement with a new LED module.

### SUMMARY OF THE INVENTION

The present invention has an object to provide a technique capable of compensating poor viewability of a display screen caused by variations in luminance characteristics of individual LEDs without the need for halting operation of an apparatus.

An LED display apparatus according to the present invention includes an LED display unit having an LED display that displays an image. The LED display has a plurality of first LEDs formed of LED sets having the same characteristics for corresponding colors. The LED display apparatus includes a controller and an LED aging unit. The controller stores cumulative lighting periods of the first LEDs of the LED display as a whole per color. The LED aging unit includes an LED aging display that includes at least one second LED located separately from the LED display and formed of an LED set having the same characteristics as those of the LED sets of the first LEDs for corresponding colors, a luminance measurer that measures luminance decrease rates of the second LED per color correspondently to lighting periods of the first LEDs, and a luminance decrease rate storage that stores the luminance decrease rates measured by the luminance measurer per color. The controller computes correction factors for correcting luminances of the first LEDs per color in accordance with the cumulative lighting periods of the first LEDs of corresponding colors stored in the controller itself and the luminance decrease rates of corresponding colors stored in the luminance decrease rate storage, and corrects the luminances of the first LEDs per color in accordance with the correction factors.

The LED display apparatus includes the LED aging display including at least one second LED located separately from the LED display. The controller computes correction factors for correcting luminances of the first LEDs per color in accordance with the cumulative lighting periods of the first LEDs of corresponding colors stored in the controller itself and the luminance decrease rates of corresponding colors stored in the luminance decrease rate storage, and corrects the luminances of the first LEDs per color in accordance with the correction factors.

In this configuration, without the need for halting the operation of the apparatus, the luminances can be corrected with a high degree of accuracy through the use of the cumulative lighting periods of the first LEDs of corresponding colors and the luminance decrease rates of corresponding colors measured correspondently to the lighting periods of the first LEDs. This can compensate the poor viewability of the display screen caused by variations in the luminance characteristics of the individual first LEDs.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an LED display apparatus according to a first preferred embodiment;

FIG. 2 is a block diagram illustrating an LED display unit of the LED display apparatus;

FIG. 3 is a block diagram illustrating an LED aging unit of the LED display apparatus;

FIG. 4 is a diagram illustrating a hardware configuration of the LED display apparatus;

FIG. 5 is a graph illustrating luminance decrease rates of green LEDs with respect to a lighting period of an LED aging display;

FIG. 6 is a graph illustrating relations between the luminance decrease rates and the lighting period of the LED aging display;

FIG. 7 is a flowchart illustrating a method for correcting luminance of the LED display apparatus;

FIGS. 8A, 8B, and 8C each illustrate an example of PWM driving;

FIG. 9 is a graph for describing the method for correcting luminance of the LED display apparatus;

FIG. 10 is a graph for describing a method for correcting luminance of the LED display apparatus according to a modification of the first preferred embodiment; and

FIG. 11 is a graph for describing a method for correcting luminance of an LED display apparatus according to a second preferred embodiment.

### DESCRIPTION OF THE PREFERRED EMBODIMENTS

### First Preferred Embodiment

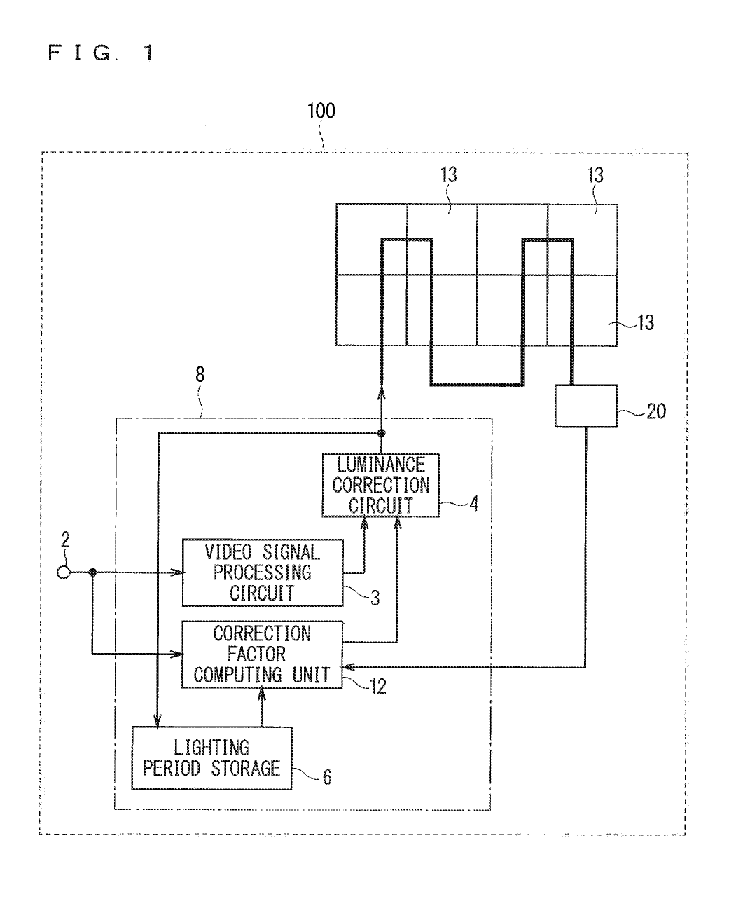

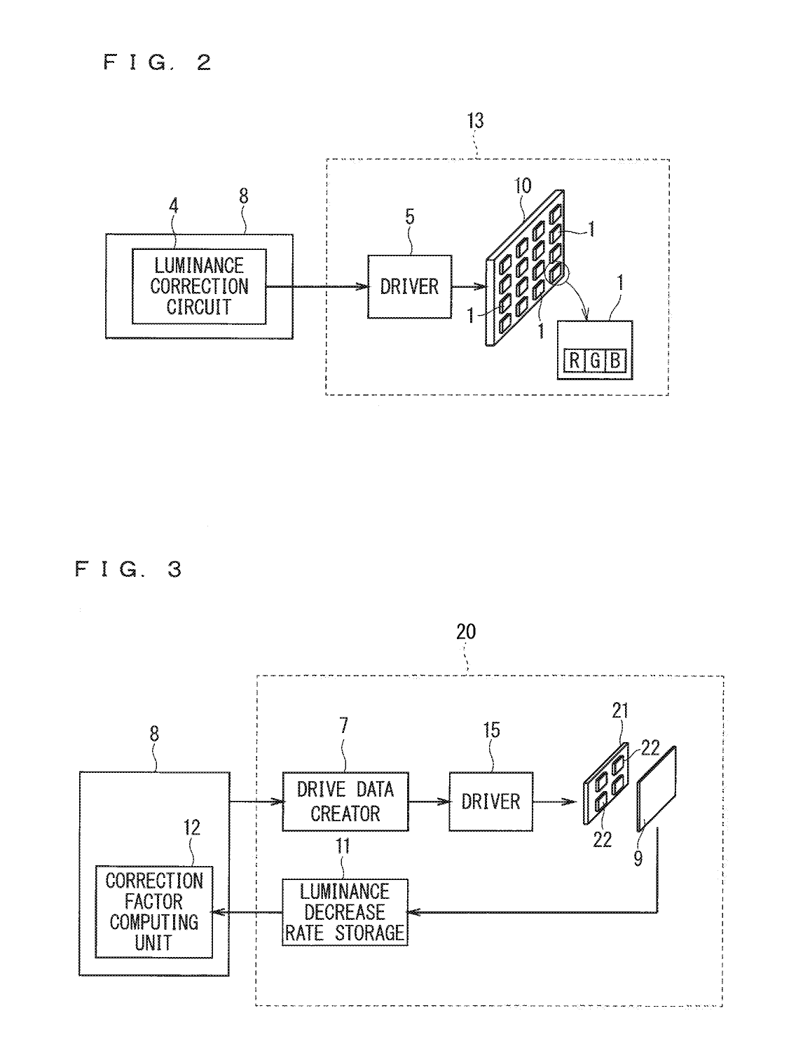

Description will be given on a first preferred embodiment of the present invention with reference to the drawings. FIG. 1 is a block diagram illustrating an LED display apparatus 100 according to the first preferred embodiment. FIG. 2 is a block diagram illustrating an LED display unit 13 of the LED display apparatus 100. FIG. 3 is a block diagram illustrating an LED aging unit 20 of the LED display apparatus 100.

As illustrated in FIG. 1, the LED display apparatus 100 includes a plurality of LED display units 13 (eight (2×4=8) units are illustrated in FIG. 1), an input terminal 2 for video signals, a video signal processing circuit 3, a luminance correction circuit 4 (a luminance corrector), a lighting period storage 6, a correction factor computing unit 12, and the LED aging unit 20. The video signal processing circuit 3, the correction factor computing unit 12, the luminance correction circuit 4, and the lighting period storage 6 are included in a controller 8.

Firstly, description will be given on the LED display units 13. As illustrated in FIG. 2, the individual LED display unit 13 includes a plurality of LEDs 1 (first LEDs) formed of LED sets having the same characteristics for corresponding colors, an LED display 10 that displays an image, and a driver 5 that drives the LEDs 1 of the LED display 10. The colors of the LEDs are, for example, red (R), green (G), and blue (B). FIG. 2 illustrates sixteen (4×4=16) LED sets as an example. Each LED set is formed of three LEDs including a red (R) LED, a green (G) LED, and a blue (B) LED.

As illustrated in FIG. 1, the video signal processing circuit 3 performs scaling processing and video signal processing including the gamma correction such that video signals input from the input terminal 2 are displayed on the LED display units 13. The luminance correction circuit 4 corrects the luminance of the signals output from the video signal processing circuit 3. The lighting period storage 6 stores cumulative lighting periods obtained by accumulating the lighting periods of LEDs 1 of the LED display 10 as a whole per color. The lighting period storage 6 is, for example, a semiconductor memory, such as a RAM.

The video signals output from the luminance correction circuit 4 are input to the LED display units 13 and the LED aging unit 20. As illustrated in FIG. 2, the output from the luminance correction circuit 4 is input to the LED aging unit 20 through the LED display units 13 located downstream of the luminance correction circuit 4, and is concurrently input to the driver 5 of the individual LED display unit 13. The driver 5 selects an area required to display an image in accordance with the input video signals, and drives the LED display 10 formed of the plurality of LEDs 1.

Then, description will be given on the LED aging unit 20. As illustrated in FIG. 3, the LED aging unit 20 includes an LED aging display 21, a driver 15, a drive data creator 7, a luminance measurer 9, and a luminance decrease rate storage 11. The LED aging display 21 includes at least one LED 22 (second LED) formed of an LED set having the same characteristics as those of the LED sets of the LEDs 1 for corresponding colors. FIG. 3 illustrates four (2×2=4) LED sets as an example. Each LED is formed of three LEDs including a red (R) LED, a green (G) LED, and a blue (B) LED.

The drive data creator 7 creates a display pattern (drive data) to be supplied to the driver 15. The driver 15 drives the LEDs 22 in the display pattern supplied from the drive data creator 7. The luminance measurer 9 measures luminance decrease rates of the LEDs 22 per color correspondently to the lighting periods of the LEDs 1, and causes the luminance decrease rate storage 11 to store the measured luminance decrease rates. The luminance decrease rate storage 11 is, for example, a semiconductor memory, such as a RAM.

The correction factor computing unit 12 computes correction factors for correcting luminances of the LEDs 1 per color in accordance with the luminance decrease rates of corresponding colors stored in the luminance decrease rate storage 11 and the cumulative lighting periods of the LEDs 1 of corresponding colors stored in the lighting period storage 6. The luminance correction circuit 4 corrects the luminances of the LEDs 1 per color in accordance with the correction factors computed by the correction factor computing unit 12.

The cumulative lighting periods stored in the lighting period storage 6 are obtained by accumulating periods of the lighting (lighting periods) of the LEDs 1 per color. The lighting periods of the LEDs 1 per fixed unit time are accumulated. Assuming that the unit time is one hour and the duty ratio is 10%, the lighting period storage 6 stores 0.1 hour of lighting period once every hour. Operation based on a method for controlling current in accordance with the duty ratio will be described later.

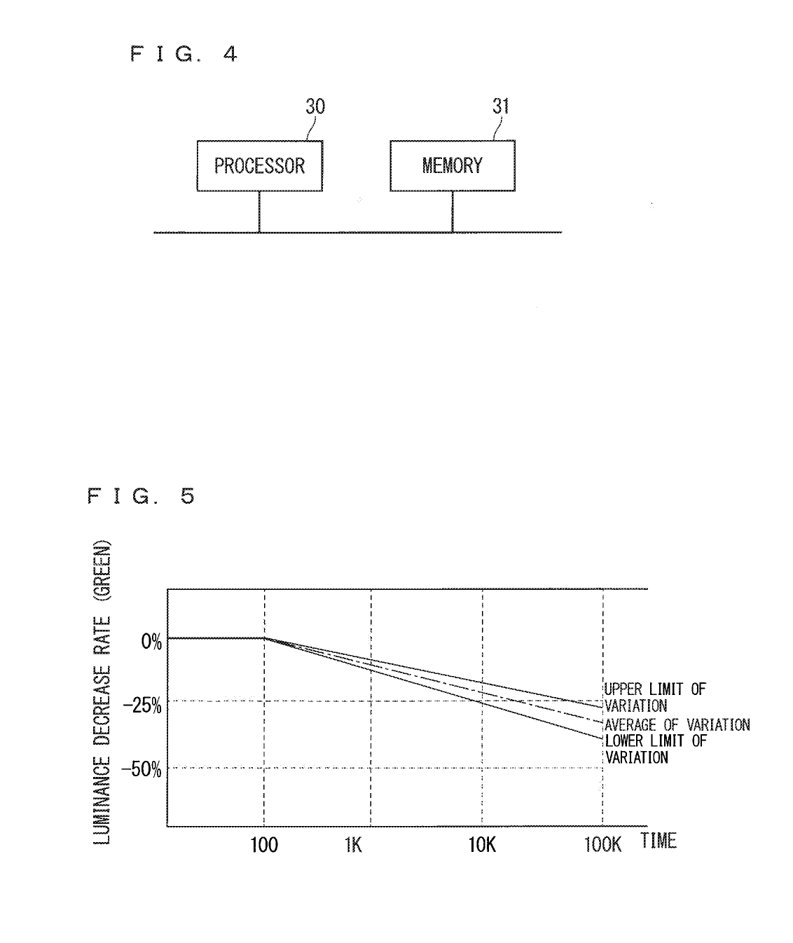

Next, description will be given on a hardware configuration of the LED display apparatus 100. FIG. 4 is a diagram illustrating the hardware configuration of the LED display apparatus 100. As illustrated in FIG. 4, the LED display apparatus 100 includes a processor 30 and a memory 31. FIG. 4 is a diagram for describing software functions of the LED display apparatus 100, and thus other constituent components are omitted from the drawing.

For example, the processor 30 in FIG. 4 executes programs stored in the memory 31 and the like, so that the correction factor computing unit 12 and the drive data creator 7 are implemented as functions of the processor 30 in the LED display apparatus 100. The correction factor computing unit 12 and the drive data creator 7 may be implemented by a plurality of processors 30 cooperating with each other.

FIG. 5 is a graph illustrating the luminance decrease rates of the green LEDs with respect to the lighting period of the LED aging display 21. As illustrated in FIG. 5, the luminances of the LEDs decrease with the lapse of lighting time. In general, the luminance decrease rates are measured in advance. In this preferred embodiment, meanwhile, the luminance decrease rates are measured in real time. The luminance decrease rates of the LEDs 22 are measured per color correspondently to the lighting periods of the LEDs 1. The following describes a method for measuring the luminance decrease rates.

The drive data creator 7 creates a display pattern to be displayed on the LED aging display 21. The driver 15 drives the LED aging display 21 in accordance with the display pattern created by the drive data creator 7. The display pattern created by the drive data creator 7 is equal to the maximum duty ratio of the display pattern of the LED display 10. In a case where the maximum duty ratio of the display pattern of the LED display 10 is 100%, it is required that the duty ratio of the display pattern of the LED aging display 21 be set at 100%. This configuration can ensure the lighting period equal to the longest lighting period among the lighting periods of the LEDs 1 of the LED display 10.

The LED aging display 21 includes at least one LED 22 having the same characteristics as those of the LEDs 1 for corresponding colors. Unlike the LED aging display 21 including a single LED 22, the LED aging display 21 including the plurality of LEDs 22 can eliminate or reduce variations through averaging. The luminance measurer 9 is opposed to the LED aging display 21 and measures the luminances of LEDs 22 of the LED aging display 21 per color. The luminance measurer 9 may be a photodiode capable of performing a measurement with light of wavelengths in the visible range.

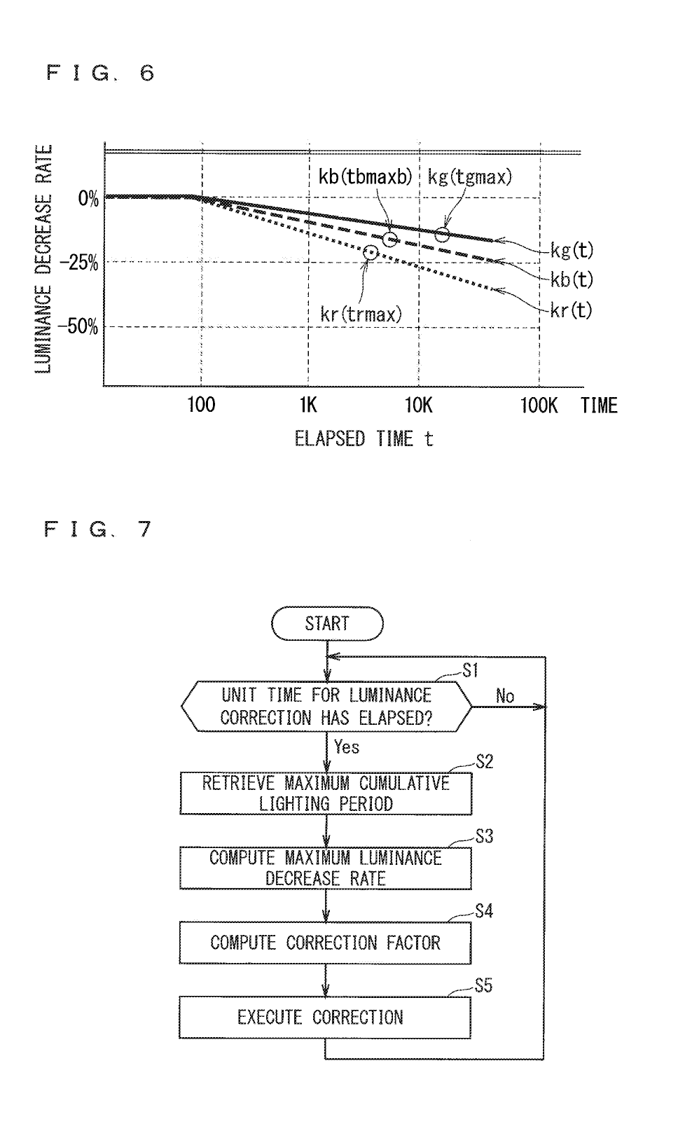

FIG. 6 is a graph illustrating relations between the luminance decrease rates and the lighting period of the LED aging display 21. The luminance decrease rates of individual colors of the LEDs 22 are denoted by kr(t), kg(t), and kb(t), which are factors of elapsed time (the lighting period) t. The measurement results obtained by the luminance measurer 9 and the lighting period of the LED aging display 21 are stored in the luminance decrease rate storage 11. This configuration allows for real-time measurement of luminance decrease rates of the individual colors with respect to the lighting time.

Next, detailed description will be given on a method for correcting luminance of the LED display apparatus 100. FIG. 7 is a flowchart illustrating the method for correcting luminance of the LED display apparatus 100. Upon starting the processing illustrated in the flowchart in FIG. 7, the correction factor computing unit 12 determines whether the unit time (for example, 100 hours) for the luminance correction has elapsed (Step S1). If the unit time for the luminance correction has not elapsed (NO in Step S1), the correction factor computing unit 12 performs the determination in Step S1 again. If the unit time for the luminance correction has elapsed (YES in Step S1), the correction factor computing unit 12 refers to the lighting period storage 6 to retrieve the maximum cumulative lighting periods of the individual colors of the LEDs 1 (Step S2).

Then, the correction factor computing unit 12 refers to the luminance decrease rate storage 11 to compute the maximum luminance decrease rate in accordance with luminance decrease rates of three individual colors being R, G, and B with respect to the maximum cumulative lighting period retrieved in Step S2 (Step S3).

To be more specific, with the maximum cumulative lighting periods of the individual colors of the LEDs 1 being denoted by trmax, tgmax, and tbmax, a maximum luminance decrease rate krgb (tmax) is given by Expression (1) including the luminance decrease rate factors kr(t), kg(t), and kb(t).

krgb(tmax)=MAX(kr(trmax), kg(tgmax), kb(tbmax)) (1)

Then, the correction factor computing unit 12 refers to the lighting period storage 6 and the luminance decrease rate storage 11 to compute correction factors for all of the LEDs 1 of the LED display 10 per color in accordance with the luminance decrease rates of corresponding colors with respect to the cumulative lighting periods and the maximum luminance decrease rate krgb(tmax) obtained in Step S3 (Step S4).

The signals output from the video signal processing circuit 3 are supplied to the luminance correction circuit 4, and the luminance correction circuit 4 corrects the luminances of the LEDs 1 per color in accordance with the correction factors computed in Step S4 (Step S5). To be more specific, with the current luminances of the individual colors R, G, and B of the LEDs 1 being denoted by Rp, Gp, and Bp, the luminance decrease rates of the individual colors with respect to a cumulative lighting period t being denoted by kr(t), kg(t), and kb(t), and the maximum luminance decrease rate being denoted by krbg (tmax), corrected luminances Rcomp, Gcomp, and Bcomp of the individual colors R, G, and B of the LEDs 1 are given by Expression (2).

$$\begin{matrix}Rcomp = Rp \times \frac{1}{( 1 - kr ( t ) )} \times ( 1 - krgb ( t max ) ) \\ Gcomp = Gp \times \frac{1}{( 1 - kg ( t ) )} \times ( 1 - krgb ( t max ) ) \\ Bcomp = Bp \times \frac{1}{( 1 - kb ( t ) )} \times ( 1 - krgb ( t max ) )\end{matrix} \} \qquad ( 2 )$$

With the initial luminances of the individual colors R, G, and B of the LEDs 1 being denoted by R0, G0, and B0, current luminances Rp, Gp, and Bp of the individual colors R, G, and B of the LEDs 1 in Expression (2) are given by Expression (3).

$$\begin{matrix}Rp = R 0 ( 1 - kr ( t ) ) \\ Gp = G 0 ( 1 - kg ( t ) ) \\ Bp = B 0 ( 1 - kb ( t ) )\end{matrix} \} \qquad ( 3 )$$

Substituting Expression (3) in Expression (2) yields Expression (4) representing the corrected luminances Rcomp, Gcomp, and Bcomp of the individual colors R, G, and B of the LEDs 1. As given by Expression (4), the luminances Rcomp, Gcomp, and Bcomp are obtained by correcting the initial values of the individual colors R, G, and B of the LEDs 1 uniformly with the maximum luminance decrease rate.

$$\begin{matrix}\begin{matrix}Rcomp = R 0 ( 1 - krgb ( t max ) ) \\ Gcomp = G 0 ( 1 - krgb ( t max ) )\end{matrix} \\ Bcomp = B 0 ( 1 - krgb ( t max ) )\end{matrix} \} \qquad ( 4 )$$

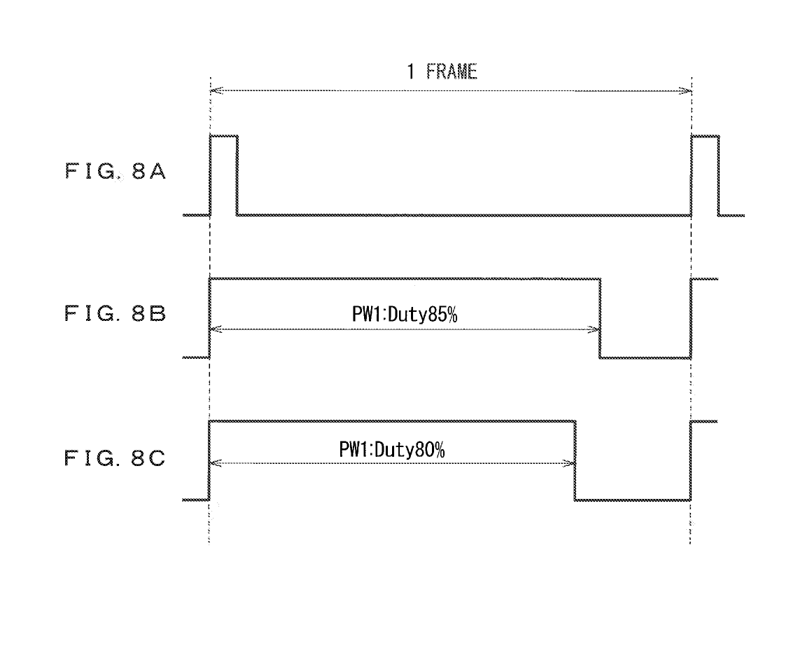

The luminances of the LEDs 1 are adjusted in accordance with a pulse width modulation (PWM) method. FIGS. 8A, 8B, and 8C each illustrate an example of PWM driving. FIG. 8A illustrates a basic cycle of the PWM, which is equal to or shorter than one frame period of a video signal. FIG. 8B is given assuming that the duty ratio of the pulse width is, for example, 85%. FIG. 8C is given assuming that the duty ratio of the pulse width is, for example, 80%. The luminances of the LEDs 1 can be adjusted by changing the duty ratio of the pulse width. In correcting the luminances of the LEDs 1, the luminances can be adjusted by changing the duty ratio of the pulse width.

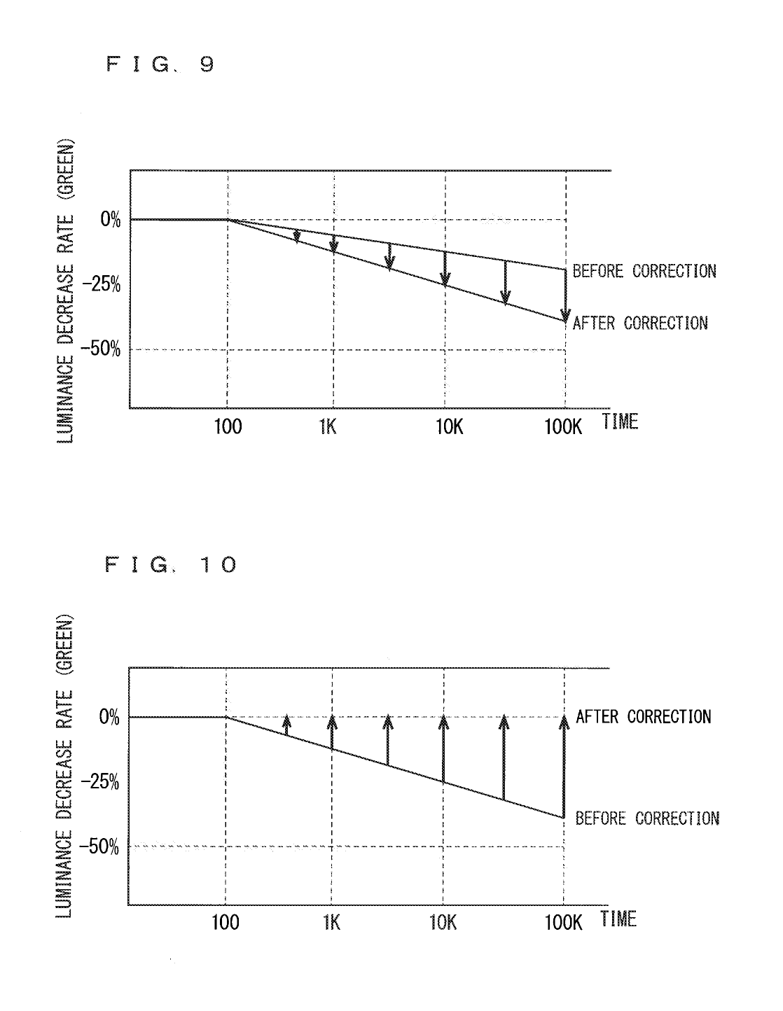

FIG. 9 is a graph for describing the method for correcting the luminance of the LED display apparatus 100. As illustrated in FIG. 9, the luminance decrease rates of the LEDs 1 of the LED display 10 are uniformly adjusted to be equal to the luminance decrease rate of a color having the longest lighting period and having undergone the greatest luminance decrease. This configuration can keep the luminance consistency and the white balance in displaying as a whole, thus reducing variations in luminance. This luminance correction method has an advantage of offering a higher initial luminance. Meanwhile, in a case where the luminances of conventional LED display units are continuously measured by a luminance sensor, the displaying by the LED display units is unfortunately obstructed by the luminance sensor. In this preferred embodiment, the luminances of the LEDs 22 are measured by the LED aging unit 20 located outside the LED display units 13, so that the chronological change of the LEDs 22 can be continuously detected, with the displaying by the LED display unit 13 not being obstructed by the luminance sensor.

As described above, the LED display apparatus 100 according to the first preferred embodiment includes the LED aging display 21 including the LEDs 22 located separately from the LED display 10. The correction factor computing unit 12 computes correction factors for correcting the luminances of the LEDs 1 per color in accordance with the cumulative lighting periods of the LEDs 1 of corresponding colors stored in the lighting period storage 6 and the luminance decrease rates of corresponding colors stored in the luminance decrease rate storage 11. The luminance correction circuit 4 corrects the luminances of the LEDs 1 per color in accordance with the correction factors computed by the correction factor computing unit 12.

In this configuration, without the need for halting the operation of the apparatus, the luminances can be corrected with a high degree of accuracy through the use of the cumulative lighting periods of the LEDs 1 of corresponding colors and the luminance decrease rates of corresponding colors measured correspondently to the lighting periods of the LEDs 1. This can compensate the poor viewability of the display screen caused by variations in the luminance characteristics of the individual LEDs 1. Thus, the consistency in luminance and color of the LED display 10 as a whole can be maintained.

The number of the LEDs 22 included in the LED aging display 21 may be increased such that the luminances can be corrected more accurately without or with minimized variations among the individual LEDs 22.

The lighting period storage 6 and the luminance decrease rate storage 11 are located outside the LED display units 13. Thus, the overall luminance of the LED display units 13 can be easily adjusted if any LED display unit 13 needs replacement in the event of a breakdown or the like.

The LED aging unit 20 further includes the driver 15 that drives the LEDs 22 and the drive data creator 7 that creates the drive data to be supplied to the driver 15. In this configuration, the luminance decrease rates of the LEDs 22 can be measured in an unsophisticated manner without necessitating actual video signals.

The correction factor computing unit 12 computes correction factors in accordance with the luminance decrease rate of a color having the longest cumulative lighting period among the cumulative lighting periods stored in the lighting period storage 6. Consequently, as illustrated in FIG. 9, the luminance decrease rates of the LEDs 1 of the LED display 10 are uniformly adjusted to be equal to the luminance decrease rate of the color having undergone the greatest luminance decrease. This can bring evenness of luminance to all of the LEDs 1, and maintain the luminance consistency of the LED display 10.

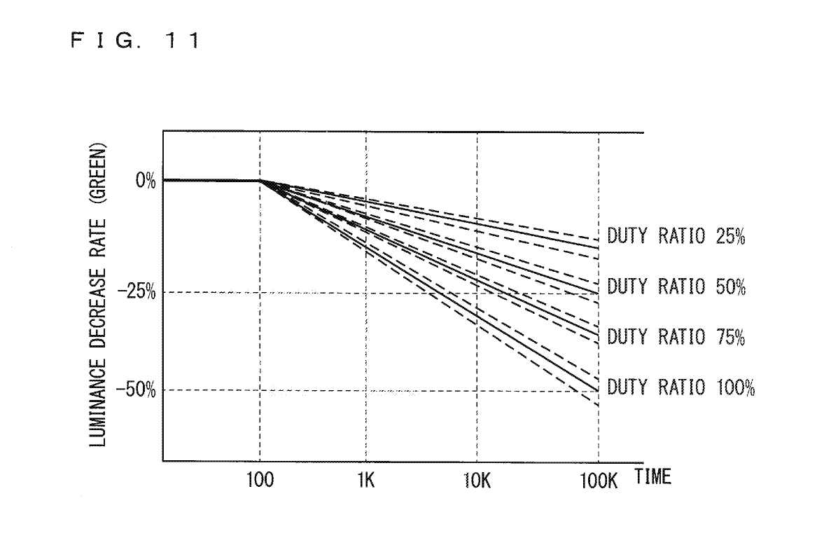

Although the luminances are corrected in such a manner that the luminance decrease rates of the individual LEDs 1 of the LED display 10 are uniformly adjusted to be equal to the luminance decrease rate of the LED that has undergone the greatest luminance decrease in this preferred embodiment, the luminance can be corrected in different manners. As illustrated in FIG. 10, assuming that the initial luminance is equivalent to, for example, about 50% of the maximum luminance, the correction factor computing unit 12 refers to the lighting period storage 6 and the luminance decrease rate storage 11 to compute correction factors of the LEDs 1 per color, and the luminance correction circuit 4 corrects the luminance in such a manner that the luminance reaches the initial luminance. Consequently, the luminance can be kept constant. FIG. 10 is a graph for describing a method for correcting the luminance of the LED display apparatus 100 according to a modification of the first preferred embodiment.

With the current luminances of the individual colors R, G, and B of the LEDs 1 being denoted by Rp, Gp, and Bp, and the luminance decrease rates of the individual colors with respect to the cumulative lighting period t being denoted by Kr(t), kg(t), and kb(t), the corrected luminances Rcomp, Gcomp, and Bcomp of the individual colors R, G, and B of the LEDs 1 are given by Expression (5).

$$\begin{matrix}Rcomp = Rp \times \frac{1}{( 1 - kr ( t ) )} \\ Gcomp = Gp \times \frac{1}{( 1 - kg ( t ) )} \\ Bcomp = Bp \times \frac{1}{( 1 - kb ( t ) )}\end{matrix} \} \qquad ( 5 )$$

Substituting Expression (3) in Expression (5) yields Expression (6) representing the corrected luminances Rcomp, Gcomp, and Bcomp of the individual colors R, G, and B of the LEDs 1. As given by Expression (6), the corrected luminances Rcomp, Gcomp, and Bcomp of the individual colors R, G, and B of the LEDs 1 are corrected to be equal to the initial values of the individual colors R, G, and B of the LEDs 1. The initial luminances (the initial values) are the luminances of the LEDs 1 set at the start of lighting.

$$\begin{matrix}\begin{matrix}Rcomp = R 0 \\ Gcomp = G 0\end{matrix} \\ Bcomp = B 0\end{matrix} \} \qquad ( 6 )$$

The luminances of the LEDs 1 at the initiation of lighting are set at the initial values, and the luminance correction circuit 4 corrects the luminances of the LEDs 1 in such a manner that the luminances of the LEDs 1 become equal to the initial values. This can maintain the luminance consistency of the LED display 10 although the LEDs 1 have low initial luminances.

In this preferred embodiment, the output from the video signal processing circuit 3 undergoes the correction of luminances of the LEDs 1. Ultimately, it is only required that a correction be made to the duty ratio of a drive signal (drive data) or a drive current of the LEDs 1, and thus the target of the luminance correction is not limited to the output from the video signal processing circuit 3.

According to the above description of this preferred embodiment, the LEDs 22 of the LED aging display 21 have the same characteristics as those of the LEDs 1 of the LED display 10 for corresponding colors. However, the luminances and the wave lengths of the individual LEDs vary from lot to lot. In general, LEDs are labeled with BIN codes for classifying LEDs according to, for example, luminance and wavelength. The luminance decrease rates can be obtained with a higher degree of accuracy if the production lot and the BIN code of the LEDs 22 of the LED aging display 21 agree with the production lot and the BIN code of the LEDs 1 of the LED display 10.

In this preferred embodiment, the video signal processing circuit 3, the correction factor computing unit 12, the luminance correction circuit 4, and the lighting period storage 6 that are included in the controller 8 as well as the LED aging unit 20 are located outside the LED display units 13. This configuration offers an advantage in that this preferred embodiment is applicable to the existing models. The controller 8 may be disposed inside the LED display units 13 in advance.

A plurality of LED display apparatuses 100 may be combined to form a video display apparatus. In particular, the LED displays 10 of the plurality of LED display apparatus 100 are combined to form a screen. This allows for upsizing of the screen, which can be used to display advertisements indoors and outdoors accordingly.

### Second Preferred Embodiment

The following description will be given on an LED display apparatus according to a second preferred embodiment. FIG. 11 is a graph for describing a method for correcting the luminance of the LED display apparatus 100 according to the second preferred embodiment. In the second preferred embodiment, the constituent components identical to the constituent components described in the first preferred embodiment are denoted by the same reference signs, and the description thereof is omitted.

As illustrated in FIG. 11, the luminance decrease rates of the individual LED 1 vary depending on the lighting rate. In the first preferred embodiment, the maximum duty ratio of the LEDs 1 of the LED display 10 and the maximum duty ratio of the LEDs 22 of the LED aging display 21 are set to be equal. However, the luminance decrease rate varies depending on the drive duty ratio of the LEDs. In this preferred embodiment, the drive data creator 7 creates the drive data having a plurality of duty ratios so as to provide a plurality of lighting periods, and the LEDs 22 are driven in accordance with the drive data having the plurality of duty ratios.

The luminance decrease rates can be measured under the condition closer to the condition during the actual drive period, and the luminance can be corrected with an extremely high degree of accuracy.

### Other Modifications

As described above, the processor 30 executes programs stored in the memory 31 and the like, so that the correction factor computing unit 12 and the drive data creator 7 are implemented as functions of the processor 30. Alternatively, the correction factor computing unit 12 and the drive data creator 7 may be implemented by a signal processing circuit in which electric circuits of the hardware perform the relevant operation. The words “processing circuitry” may be used to describe the concept obtained by combining the correction factor computing unit 12 and the drive data creator 7 of the software with the correction factor computing unit 12 and the drive data creator 7 of the hardware.

In the present invention, the above preferred embodiments can be arbitrarily combined, or each preferred embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. An LED display apparatus, which includes an LED display unit having an LED display that displays an image, said LED display having a plurality of first LEDs formed of LED sets having the same characteristics for corresponding colors, the LED display apparatus comprising:
a controller that stores cumulative lighting periods of said first LEDs of said LED display as a whole per color; and
an LED aging unit including
an LED aging display that includes at least one second LED located separately from said LED display and formed of an LED set having the same characteristics as those of said LED sets of said first LEDs for corresponding colors,
a luminance measurer that measures luminance decrease rates of said second LED per color correspondently to lighting periods of said first LEDs, and
a luminance decrease rate storage that stores the luminance decrease rates measured by said luminance measurer per color,
wherein said controller computes correction factors for correcting luminances of said first LEDs per color in accordance with said cumulative lighting periods of said first LEDs of corresponding colors stored in said controller itself and the luminance decrease rates of corresponding colors stored in said luminance decrease rate storage, and corrects the luminances of said first LEDs per color in accordance with said correction factors.

2. The LED display apparatus according to claim 1, wherein said LED aging unit further includes a driver that drives said second LED and creates drive data to be supplied to said driver.

3. The LED display apparatus according to claim 1, wherein said controller computes said correction factors in accordance with the luminance decrease rate of a color having the longest cumulative lighting period among said cumulative lighting periods stored in said controller itself.

4. The LED display apparatus according to claim 1, wherein
the luminances of said first LEDs at a start of lighting are set at initial values, and
said controller corrects the luminances of said first LEDs in such a manner that the luminances of said first LEDs become equal to said initial values.

5. The LED display apparatus according to claim 2, wherein
said LED aging unit creates drive data having a plurality of duty ratios so as to provide a plurality of lighting periods, and
said second LED is driven in accordance with said drive data having the plurality of duty ratios.

6. A video display apparatus comprising a plurality of said LED display apparatuses according to claim 1, wherein said LED displays of said plurality of LED display apparatuses are combined to form a screen.
